(19) United States
(12) Patent Application Publication
(10) Pub. No.: US 2007/0251140 A1
(43) Pub. Date: Nov. 1, 2007

(54) Candle wax with a thermal diffusive additive

(75) Inventor: Mark A. Spangler, Goode, VA (US)

Correspondence Address: R. TRACY CRUMP, P.O. BOX 604, 32790 DUNN ROAD, NEW CARLISLE, IN, 46552, US

(73) Assignee: Smith Mountain, Industries, Inc.

(21) Appl. No.: 11/712,550

(22) Filed: Feb. 28, 2007

Related U.S. Application Data
(60) Provisional application No. 60/778,233, filed on Mar. 2, 2006.

(51) Int. Cl. C11C 5/00

(52) U.S. Cl. 44/275

(57) ABSTRACT

The candle wax includes an additive for increasing the thermal diffusivity of the wax, which allows the candle wax to transfer and retain more thermal energy. The thermal diffusive additive increase the thermal conductivity and/or specific heat of the candle waxes and can be used with any conventional candle wax to improve the formation and size of the melt pool in a jar candle.

### BACKGROUND

Apothecary jar candles and other containerized candles (“jar Candles”) are well known and often used for aroma as well as illumination. A typical jar candle consists of a glass jar or vessel filled with a volume of candle wax and a combustible fibrous wick embedded in the candle wax. The candle wax is the fuel, which is consumed in the burning of the candle. When burnt, the heat from the candle flame melts the surrounding candle wax, which is drawn up the wick by capillary action and combusted. Beeswax, paraffin and stearin are common fuels for candle waxes. Candle waxes have also been developed from vegetable oils, such as oleic acid (soy wax) and lauric acid (tropical oil wax).

Essential oils are often added to these candle waxes to provide fragrance to the candles. While essential oil particulate are released in the combustion of the candle wax, much of the candle's aroma is the result of essential oil particulate being diffused into the atmosphere directly from the pool of melted candle wax. The amount of fragrance or scent that a candle gives off is commonly referred to as the candle's “scent throw.” The size of the surface area of the “melt pool” greatly enhances the dissemination of scent from the candle wax. Obviously, the larger the surface area of the melt pool, the more scent particulate can be dissipated into the atmosphere.

For a jar candle, the melt pool should extend across the entire inner diameter of the jar. When the melt pool covers the entire inner diameter of the jar, the scent throw is maximized and “tunneling” is eliminated. “Tunneling” occurs in jar candles and wide pillar candles. Only the melted candle wax is consumed in the combustion. Any unmelted candle wax around the sides of the jar is lost as a fuel source and the candle's burn life is reduced. As the melted candle wax is consumed in combustion, the flame “tunnels” into a well of unmelted candle wax around the sides of the jar. This “tunneling” effect detracts from the appearance of the candle.

Heretofore, attempts to improve the formation and size of melt pools in jar candles have focused on lowering the melt point of the candle waxes. Candle waxes have been formulated to add chemical ingredients with lower-melt points; however, adding lower melt ingredients to candle waxes can impede the development of melt pools. In many cases these additives are better thermal insulator than the raw candle waxes.

The real problem in the formation of melt pools in jar candles arises from the fact that the combustion of conventional candle waxes often does not generate enough thermal energy to from a melt pool across the entire inner diameter of a jar candle. The heat and light from the candle flame is not conveyed any significant distance through convection, conduction or radiation. The fuels used as conventional candle waxes simply do not transfer heat well. Conventional candle waxes have a relatively lower thermal conductivity (the measure of a material's ability to conduct heat) and a relative high specific heat capacity (the thermal property of a material equal to the amount of energy required to raise the temperature of the material by 1° Celsius). Consequently, the thermal properties, specifically the thermal diffusivity (the ability to transfer thermal energy) of conventional candle waxes limits the formation and size of melt pools in jar candles.

### SUMMARY

This invention relates to candle waxes, and in particular, candle wax having an additives for increasing the thermal diffusivity of the wax. The thermal diffusive additives increase the thermal conductive and/or specific heat of the candle waxes. The thermal diffusive additives can be used with any conventional candle wax to improve the formation and size of the melt pool in a jar candle. The thermal diffusive additives allow the candle wax to transfer and retain more thermal energy. Theses and other advantages of the present invention will become apparent from the following description of the candle waxes embodying this invention.

### GRAPHS

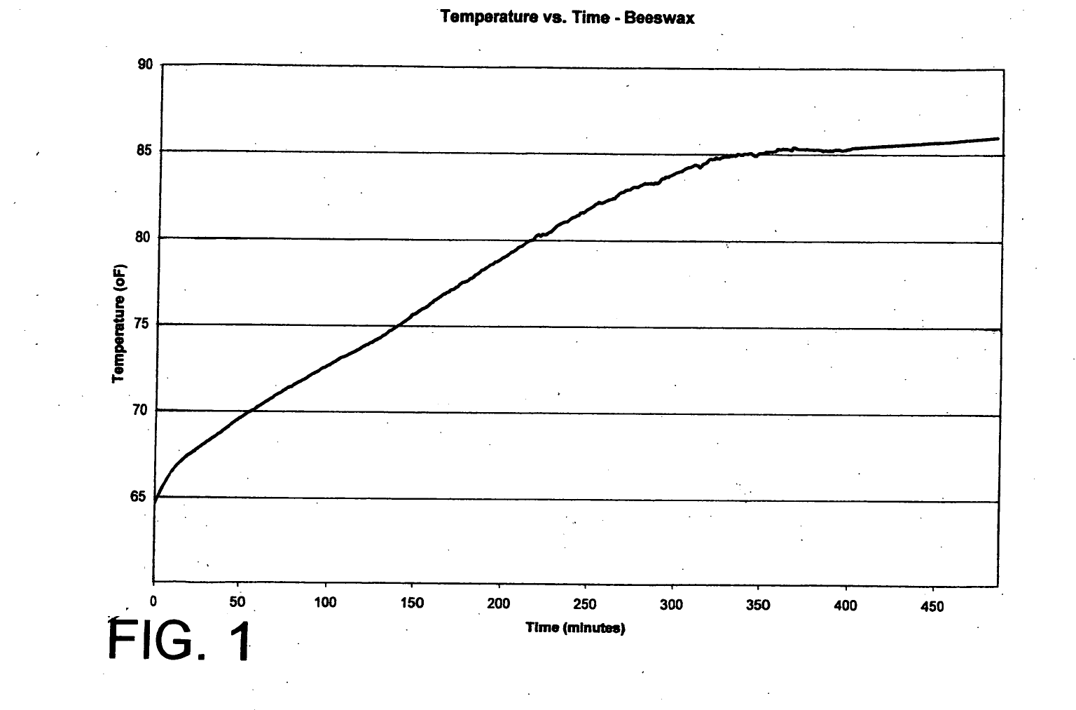

FIG. 1 is a graph of melt pool temperature verses time for a candle wax containing only beeswax;

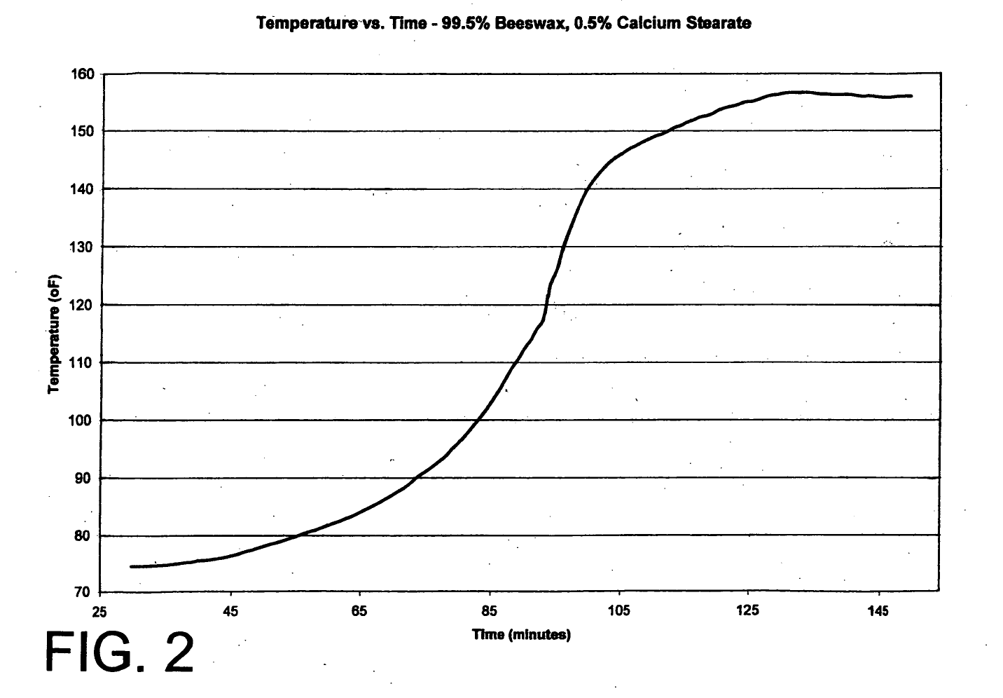

FIG. 2 is a graph of melt pool temperature verses time for a candle wax containing 99.5% beeswax and 0.5% Calcium Stearate;

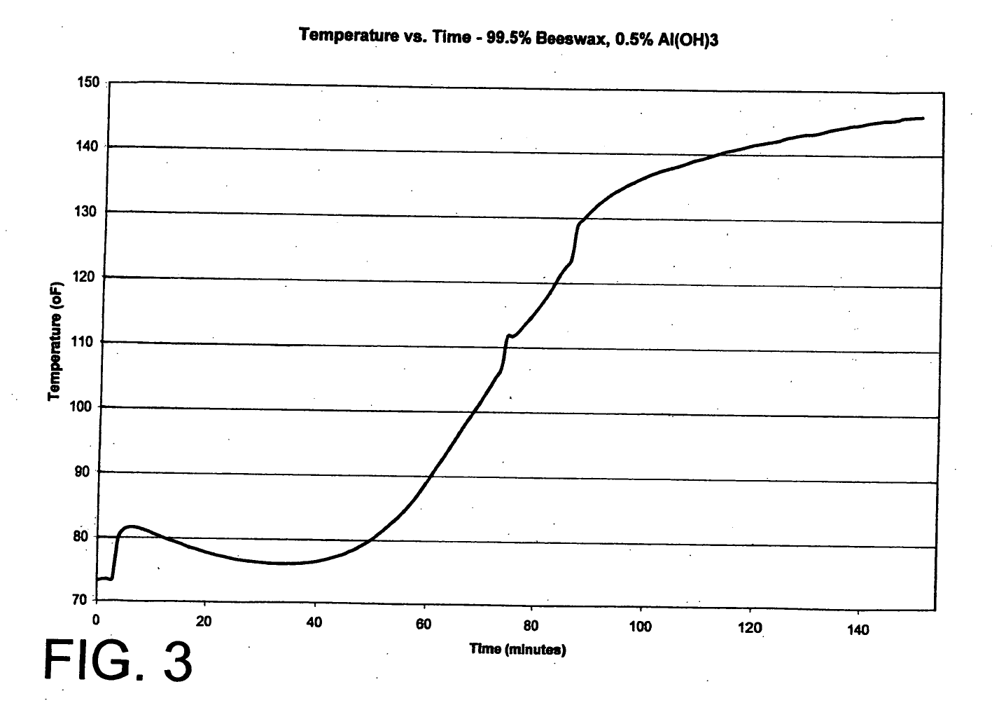

FIG. 3 is a graph of melt pool temperature verses time for a candle wax containing 99.5% beeswax and 0.5% aluminum hydroxide;

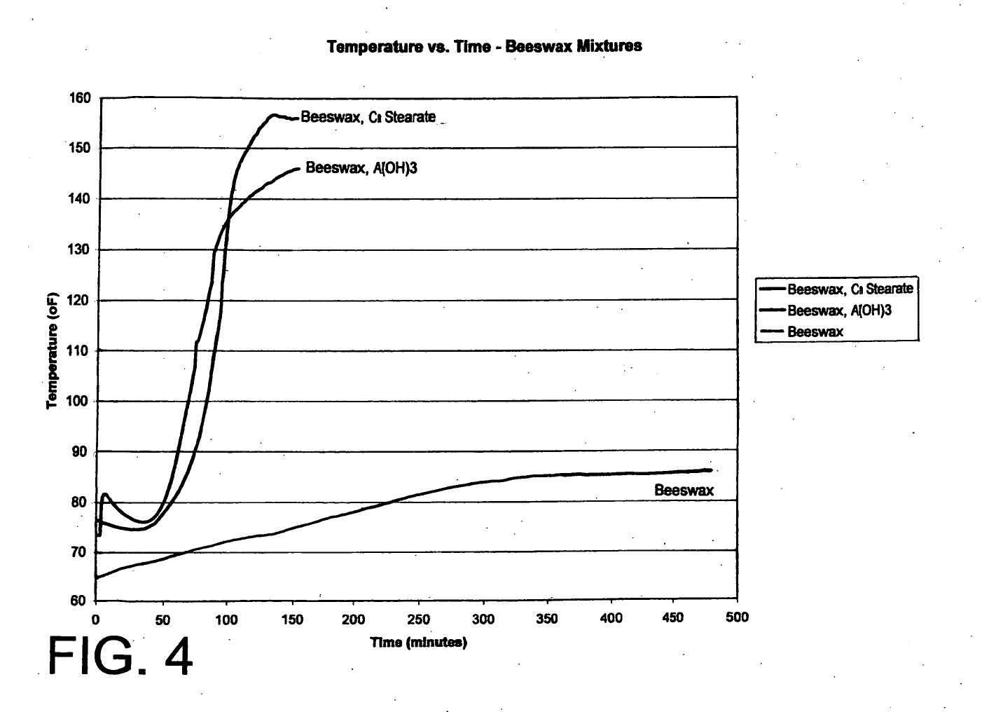

FIG. 4 is a graph of melt pool temperature verses time combining the data from FIGS. 1-3; and

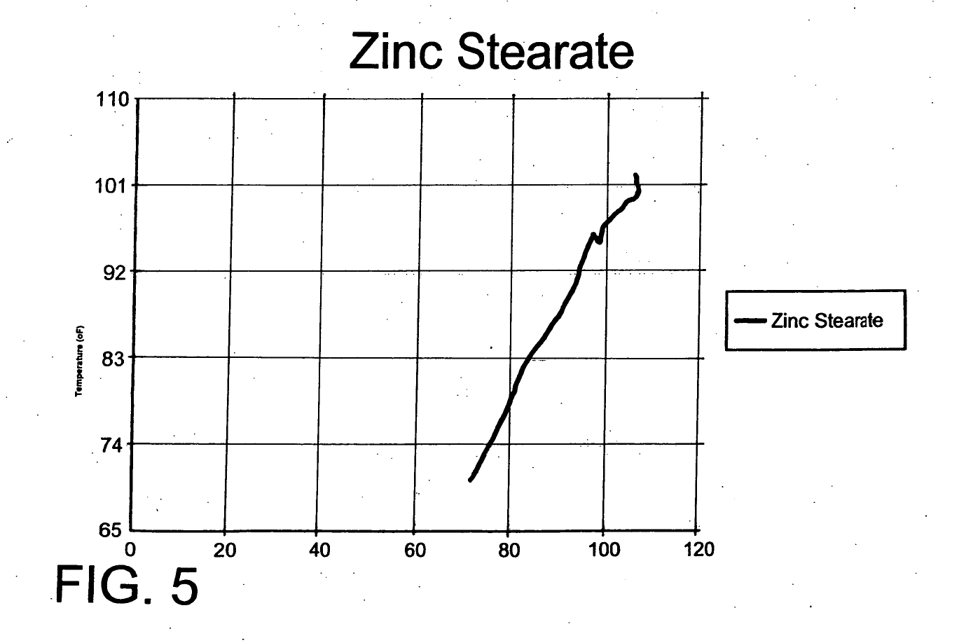

FIG. 5 is another graph of melt pool temperature verses time for a candle wax containing 99.5% beeswax and 0.5% Zinc Stearate.

### DETAILED DESCRIPTION

The candle wax mixtures embodying this invention have thermal properties that enhance the formation and size of melt pools in jar candles. Each embodiment of the candle waxes includes chemical additives that improve the thermal conductivity and/or specific heat capacity to maximize the overall thermal diffusivity of the wax. These thermal diffusive additives allow the candle wax to transfer and retain more thermal energy, which is evidenced by graphing the temperature of the melt pool over time. The thermal diffusive additives of this invention greatly enhance the thermal properties of the candle waxes, resulting in hotter and larger melt pools within a jar candle. These thermal diffusive additives can be added to any conventional candle wax formulation within the teaching of this invention, including but not limited to beeswax, paraffin waxes and soy waxes.

The thermal diffusive additives may be selected from a variety of chemical compounds having sufficient thermal conductivity and/or specific heat capacity. The thermal diffusive additives are selected and formulated with the candle waxes so as to remain suspended in the wax. These chemical compounds may include metals, such as, aluminum, copper, gold, potassium, silver or zinc or non-metals, such as, calcium.

In one embodiment using a metal based additive, the candle wax mixture consists of 99.5% beeswax and 0.5% aluminum hydroxide —Al(OH)₃. In a second embodiment of the candle wax mixture using a non-metal based thermal conductive additive, the candle wax mixture consists of 99.5% beeswax and 0.5% Calcium Stearate —[CH₃(CH₂)₁₆CO₂]₂Ca. In a third embodiment, the candle wax mixture consists of 99.5% beeswax and 0.5% Zinc Stearate —Zn(C₁₈H₃₅O₂)₂.

As shown in FIG. 1-5, each embodiment of the candle wax mixture show marked increases in wax pool temperature over the base candle wax without a thermal diffusive additive. It should be noted that the amount of thermal diffusive additive in each embodiment is less than one percent of the total volume.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A composition comprising: candle wax; and an additive having a thermal diffusivity greater than the candle wax.

2. A composition comprising: 99.5% beeswax; and 0.5% calcium stearate.

3. A composition comprising: 99.5% beeswax; and 0.5% aluminum hydroxide.

4. A composition comprising: 99.5% beeswax; and 0.5% zinc stearate.
